(19) United States
(12) Patent Application Publication
(10) Pub. No.: US 2002/0001736 A1
(43) Pub. Date: Jan. 3, 2002

(54) Magnetic recording medium

(76) Inventors: Hideyuki Akimoto, Isehara-shi (JP); Kenji Sato, Atsugi-shi (JP); Yuki Yoshida, Ebina-shi (JP); Iwao Okamoto, Atsugi-shi (JP)

Correspondence Address: GREER, BURNS & CRAIN, 300 S WACKER DR, 25TH FLOOR, CHICAGO, IL, 60606, US

(21) Appl. No.: 09/498,956

(22) Filed: Feb. 4, 2000

(30) Foreign Application Priority Data
May 28, 1999 (JP) 11-150071

(51) Int. Cl. G11B 5/65

(52) U.S. Cl. 428/694 T

(57) ABSTRACT

A magnetic recording medium for high density recording has a high signal to noise ratio and improved read out characteristics. The medium is made on a non-magnetic substrate having a magnetic layer containing Co, with about 26 to 35 at % Cr and about 0.5 to 4 at % Ta added. The magnetic layer can also have about 15 to 30 at % Pt, and Nb. An underlayer can be provided between the substrate and the magnetic layer, the underlayer containing Cr as its main constituent and containing one or more of Mo, W, Ti, Ir, Ru and Re.

This invention relates to a magnetic recording medium used in a magnetic disk, and more particularly to structures and materials of a magnetic recording medium film for realizing a high signal to noise ratio (S/N) when reading information with a magneto-resistance effect type magnetic head.

### BACKGROUND OF THE INVENTION

Disk shaped magnetic disks which can be randomly accessed are widely used as computer information memory media. Magnetic disks which use solid materials (for hard disk drives (HDD) and the like) such as aluminum and glass as a substrate are primarily used since they are superior in terms of response and memory capacity.

Greater demands for increased density in magnetic disks have come with increased reliance on information technology in recent years. In prior art technology, a Cr underlayer is placed on a non-magnetic substrate such as an aluminum substrate, and a recording layer which uses a magnetic alloy which has Co as its main constituent is placed over the underlayer. In order to reduce the noise level of a magnetic recording medium, it is better to reduce the size of magnetic particles or break the magnetic interaction between magnetic particles. In this connection, various additives have been studied.

Japanese Unexamined Patent Application Kokai 7-50008 discloses a magnetic recording medium which has Co as the main constituent of its magnetic layer, and contains 5 to 20 at % of Cr, 1 to 20 at % of Pt, and 0.5 to 6 at % of one or more of Nb, Hf, W, Ti or Ta in order to reduce noise. In addition, Japanese Unexamined Patent Application Kokai 9-293227 discloses a magnetic recording medium which has Co as the main constituent of its magnetic layer, and contains 14 to 25 at % of Cr, 2 to 20 at % of Pt, and 1 to 7.5 at % of Ta to obtain favorable characteristics when using a magneto-resistance type head to read out magnetically recorded information.

The present inventors studied the magnetostatic characteristics and electromagnetic conversion characteristics of CoCrPtTa₂ with various compositional ranges and layer forming conditions disclosed in the unexamined published patent application 7-50008 noted earlier, and found that a magnetic recording medium containing a substrate layer consisting of Cr and a magnetic layer consisting of Co₇₅Cr_{12.5}Pt_{7.7}Ta₂ did not have sufficient recording characteristics with a recording density of 3 Gbit/in² or greater, which is presently considered desirable. The reason for this is that the magnetic recording medium in the previously noted publication is one for which optimal characteristics can be obtained with an inductive head (MIG type), which is inadequate, in high density recording because Br is 300 Gμm and the magnetic coercive force is 1700 Oe.

Again, in the magnetic recording medium disclosed in published unexamined patent application Hei 9-293227, the element and magnetic properties of a magnetic recording layer are optimized so that optimal characteristics can be obtained in combination with an MR read head, which is frequently applied in the recording density ranges of 1 Gbit/in² or greater.

However, large magneto-resistance type heads (GMR heads) which have significant readout sensitivity, such as spin valves etc., have been developed in recent years, and there has been even greater demand for improvement in readout characteristics and conversion to greater signal to noise ratios. While increasing the density of Cr and Ta is effective in increasing signal to noise ratio, saturation magnetization, which is necessary to obtain good readout characteristics, decreases. That is to say, there is a trade-off relationship between readout characteristics and signal to noise ratio, and it is difficult to optimally have both at the same time. Satisfactory values for both readout characteristics and signal to noise ratio were not obtained with the composition of Cr and Ta in the publicly disclosed example noted earlier. Thus, there is a need for magnetic recording media which have both a high signal to noise ratio and high saturation magnetization.

### OBJECTS OF THE INVENTION

Thus, one object of the present invention is to provide a new magnetic recording medium which can achieve high recording density.

Another object of this invention is to provide a new magnetic recording medium which has low noise and also has good readout characteristics.

Still another object of the present invention is to increase the reliability of magnetic recording media.

### SUMMARY OF THE INVENTION

In order to solve the problem described above, a magnetic recording medium has a magnetic layer containing Co, with 26 to 35 at % Cr and 0.5 to 4 at % Ta added. Increasing Cr concentration is possible by keeping the Ta concentration within the above range, and yields a high signal to noise ratio not obtained in the past. The result is that it has become possible to simultaneously improve readout characteristics and reduce noise. The magnetic layer can also have 15 to 30 at % Pt, which gives the layer a high magnetic anisotropy and a high coercive force (Hc).

An underlayer having Cr as its main constituent can be disposed between a non-magnetic substrate and the previously noted magnetic layer containing CoCrPtTa, which improves the in-plane orientation of CoCrPtTa and produces a high coercive force (Hc).

The previously described magnetic layer containing CoCrPtTa may have Nb added. Magnetic particle size and particle size distribution can be controlled and noise can be further reduced by the addition of Nb.

In addition, a non-magnetic intermediate layer having a hexagonal close-packed structure may be provided between the non-magnetic underlayer and the previously described magnetic layer containing CoCrPtTa. This facilitates uniformity of magnetic particle size of the magnetic layer and reduces/controls the destruction of magnetic information due to heat. The result is that magnetic information may be maintained for a long period in a stable state, and the reliability of the magnetic recording media is improved.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1(a) and FIG. 1(b) are cross-sectional views of recording media of this invention;

FIG. 2 is a diagram which shows the relationship between a bcc crystal of Cr of a substrate layer and the crystal of a hexagonal close-packed structure crystal of CoCrPtTa of a magnetic layer;

FIG. 3 is a top view of a magnetic disk device of this invention;

FIG. 4 is a cross-sectional view of the magnetic device of FIG. 3, taken along line A-A;

FIG. 5 is a graph showing the Cr concentration dependence characteristics of saturation magnetization of a CoCrPtTa medium;

FIG. 6 is a graph which maps the saturation magnetization of a CoCrPtTa medium according to Cr concentration and Pt concentration;

FIG. 7 is a graph which shows the Cr concentration dependence characteristics of a solitary wave signal to noise ratio of a CoCrPtTa medium;

FIG. 8 is a graph showing the Ta concentration dependence characteristics of saturation magnetization of CoCrPtTa media;

FIG. 9 is a graph showing the Ta concentration dependence characteristics of saturation magnetization of CoCrPtTa media;

FIG. 10 is a graph showing the Pt concentration dependence characteristics of coercive force (Hc) of CoCrPtTa media;

FIG. 11 is a graph showing the Mo concentration dependence characteristics of a bcc (110) plane interval of a CrMo substrate layer;

FIG. 12 is a graph showing the Mo concentration dependence characteristics of coercive force (Hc) in a CoCrPtTa medium;

FIG. 13 is a graph showing the CoCrMo intermediate layer thickness dependence characteristics of coercive force (Hc) in a CoCrPtTa medium;

FIG. 14 is a graph showing the CoCrMo intermediate layer thickness dependence characteristics of solitary wave signal to noise ratio of a CoCrPtTa medium;

FIG. 15 is a graph showing the CoCrMo intermediate layer Mo additive concentration dependence characteristics of solitary wave signal to noise ratio of a CoCrPtTa medium; and

FIG. 16 is a graph showing the results of heat resistance evaluation of magnetization due to the presence or absence of a CoCrMo intermediate layer of a CoCrPtTa medium.

### DETAILED DESCRIPTION

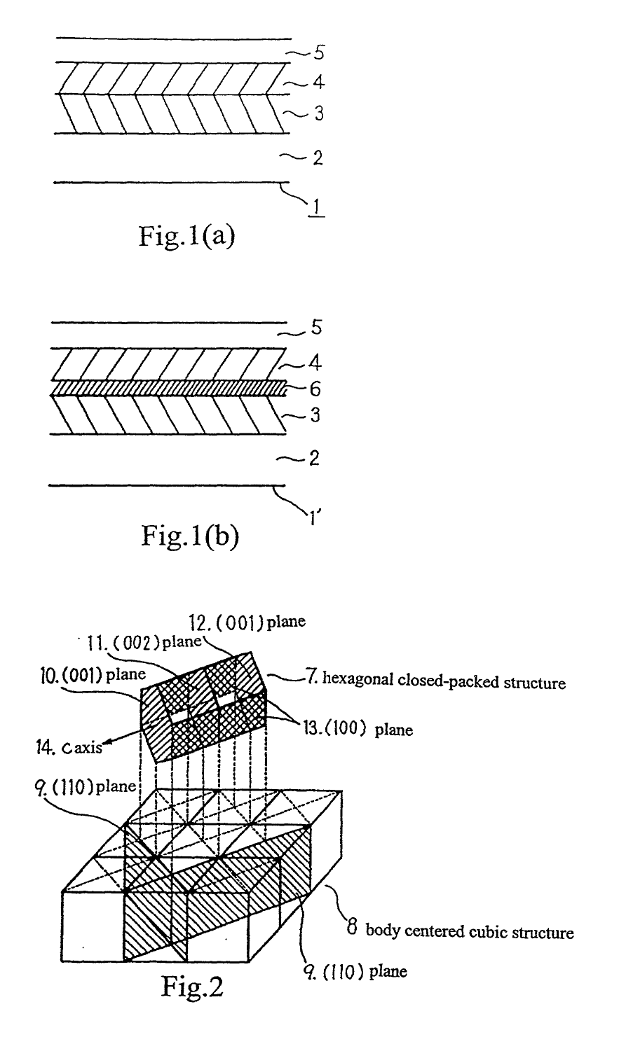

A cross sectional view of magnetic recording medium 1 of this invention is shown in FIG. 1(a). More specifically, an underlayer 3, a magnetic film 4 and a protective film 5 are formed in that order on a substrate 2.

The substrate 2 is a nonmagnetic body which is disk shaped. Suitable materials constituting substrate 2 include a NiP layer formed by plating or sputtering covering such things as an aluminum (including aluminum alloys) disk, a glass disk (including reinforced glass), a silicon disk having a surface oxidized film, an SiC disk, carbon disk, plastic disk, or ceramic disk. Substrate 2 may or may not be texture processed.

The primary constituent of magnetic film 4 is cobalt, with magnetic materials containing 26 to 35 at % chrome, 15 to 30 at % platinum and 0.5 to 4 at % tantalum. Magnetic film 4 is normally formed by magnetron sputtering methods and appropriate conditions for forming this film might be, for example, a substrate temperature of 160 to 280 C, an Ar gas pressure of 3 to 20 mTorr, and electric power input of 0.5 to 3 kW.

The criterion for reading information by an MR head and a GMR head is a saturation magnetization (Ms) of 200 emu/cm³ or more. While readout output can be assured by increasing the film thickness with a medium that has 200 emu/cm³ or less, thickening the magnetic layer increases the distribution of the magnetic field of the recording head and makes it difficult to record magnetic information clearly. In other words, 25 nm or less is preferable since extreme thickening of the magnetic layer will lead to degradation of recording readout characteristics.

In CoCrPtTa alloys, saturation magnetization and signal to noise ratio tend to be easily influenced by additive concentrations of Cr and Ta. Saturation magnetization tends to decrease to the extent that the concentration of Ta and Cr is high, and signal to noise ratio tends to increase as concentrations of Ta and Cr increase. Thus, concentrations of Cr and Ta within an appropriate range are needed in order to obtain large saturation magnetization and high signal to noise ratio; 26 to 35 at % Cr and 0.5 to 4 at % of Ta is preferable.

Adding Pt increases the coercive force (Hc) of a CoCrPtTa medium. It is thought that a coercive force (Hc) of 2500 Oe or greater is necessary in a magnetic recording medium which exceeds 3 Gbit/in². In increasing the magnetic coercive force of a magnetic layer in a CoCrPtTa medium, individual magnetic particles of the medium have a high magnetic anisotropy and an easily magnetized axis can be arranged, preferentially in the plane of a medium. If the amount of Pt added to CoCrPtTa is increased, the magnetic anisotropy that particles have will increase, and coercive force (Hc) will increase. In order to guarantee the coercive force (Hc) of 2500 Oe necessary for high density recording, an added concentration of Pt of 15 at % or greater is preferable. However, if the added concentration of Pt gets too high, the hexagonal close-packed structure of Co is disturbed and magnetic anisotropy decreases. An added concentration of Pt of 30 at % or less is preferable to stabilize the hexagonal close-packed structure of Co of CoCrPtTa alloys. In other words, the added concentration of Pt should preferably be in a range from 15 at % to 30 at % in order to obtain high coercive force (Hc) and stabilize the hexagonal close-packed structure.

If Nb is added to a magnetic layer configured with CoCrPtTa, the size and distribution range of magnetic particles can be controlled. As will be explained later, the noise of a medium can be controlled by reducing the size and distribution range of magnetic particles. A concentration of Nb of 1 to 4 at % is preferred.

Underlayer 3 increases the coercive force (Hc) of a magnetic recording medium further, and construction and material may be chosen to provide a magnetic recording medium suitable for high density recording. An underlayer using CoCrPtTa for a magnetic layer 4 will be explained.

Underlayer 3 is formed by a sputtering method such as magnetron sputtering. Appropriate conditions would include, for example, a substrate temperature of 160° C. to 280° C., an Ar gas pressure of 3 to 20 mTorr, and electric power input of 0.5 to 3 kW.

In a magnetic recording medium having a CoCrPtTa magnetic layer, the C axis of CoCrPtTa having a hexagonal structure (hcp) should be arranged in a plane in order to obtain ideal coercive force (Hc) in high surface recording density. This is realized by choosing an underlayer to mediate between the CoCrPtTa layer and nonmagnetic layer 2.

Cr is a metal which has a bcc structure and under certain layer forming conditions, with Cr on a nonmagnetic substrate 2, a bcc (100) plane will extend in parallel with the nonmagnetic substrate 2. When a CoCrPtTa magnetic layer 4 extends on this Cr alloy, as FIG. 2 shows, the bcc (110) plane interval of a Cr underlayer and the hexagonal close-packed structure (002) plane interval of a CoCrPtTa magnetic layer 4 are nearly equal so that the C axis of the hcp has a structure oriented preferentially in the film plane. The mechanism for the C axis of CoCrPtTa being preferentially oriented in the plane is due to the interval of the bcc (110) plane of Cr and the hcp (002) plane of CoCrPtTa being nearly equal. As for the CoCrPtTa alloy indicated by this invention, the interval of the hcp (002) plane extends more than the Co simple substance, with the chief factor being the addition of Pt with a larger atomic radius than the Co simple substance. That is to say, one needs to broaden the bcc (110) plane interval of Cr in line with the plane interval of the magnetic layer in order to obtain a good C axis in-plane orientation for CoCrPtTa. While an element that has an atomic radius larger than Cr may be added to broaden the lattice interval of Cr, the inventors obtained optimal results by adding Mo. Besides Mo, the same effect may be obtained by adding W, Ti, Ir, Ru and Re, etc.

FIG. 1(b) shows a magnetic recording medium 1′ in which a non-magnetic intermediate layer 6 is provided between underlayer 3 and magnetic layer 4. In particular, the crystalline orientation of magnetic layer 4 can be enhanced by providing an intermediate layer which has a nonmagnetic hexagonal close-packed structure between underlayer 3, composed of Cr alloy, and magnetic layer 4, containing CoCrPtTa alloy. A nonmagnetic material that has an hexagonal close-packed structure the same as magnetic layer 4 will not have an adverse influence on magnetic recording readout characteristics, and will suffice for materials for the intermediate layer 6.

While Co is a typical material having an hcp structure, it will be understood that since it is used also in the magnetic layer, it also is magnetic. However, when Cr is added to Co it becomes nonmagnetic when the Cr concentration becomes about 35 at %. As the concentration of Co increases further, it changes from an hexagonal close-packed structure to a bcc structure, and it becomes impossible to achieve the goal of improving the crystalline orientation of the magnetic layer. The upper limit of Cr concentration for obtaining an hcp structure stably with sputtering methods is around 45 at %.

Also, as discussed in the explanation of underlayer 3, lattice conformation with each layer is important in order to obtain favorable magnetic characteristics. By adding Mo, which has a large atomic radius for obtaining lattice conformation with each layer and is a material which does not disturb the hcp structure, a magnetic recording medium optimal for high density recording can be provided. In addition, elements which can achieve the objective of widening the lattice interval of CoCr alloys are W, Ti, Ta, Nb, Ir, Ru and Re. By adding these respective elements to CoCr alloys, an optimal magnetic recording medium can be provided for high density recording.

Another reason for providing the nonmagnetic intermediate layer 6 is to control the crystal particle size of the magnetic layer 4. Medium noise in magnetic recording occurs due to various random aspects of a medium. For example, there are variations in the distribution of the layer (surface roughness) and magnetic properties between magnetic particles. These variations are mitigated by providing intermediate nonmagnetic layer 6, which improves recording readout characteristics. In addition, together with the recent thinning of magnetic layers, the ratio of the anisotropic energy KuV that a magnetic particle has (the product of anisotropic energy Ku per unit of volume that a magnetic particle has and the volume V of magnetic particles) to the thermal energy kBT (the product of Boltzmann's constant kB and the atmospheric temperature expressed by absolute temperature T) (KuV/kBT) decreases over time and the reduction of magnetically recorded information (thermomagnetic mitigation) continues noticeably. Since the loss of magnetic information results from KuV having small particles, it is important to have magnetic particles of a uniform size, particularly to reduce the number of particles that are extremely small. Uniformity of magnetic particle sizes is enhanced by using an intermediate layer of CoCrMo, and a medium with superior thermal stability of magnetic recorded information can be provided.

Protective layer 5 consists of simple carbon substances or compounds which contain carbon. For example, WC, SiC, B4C, carbon containing hydrogen, and diamond-like carbon (DLC) are suitable, in part because they are very hard. Protective layer 5 is normally formed by magnetron sputtering methods and appropriate conditions for forming this film might be, for example, a substrate temperature of 200 C or less, an Ar gas pressure of 5 to 20 mTorr, and electric power input of 1 to 3 kW. Other methods of layer forming may also be used, for example, vapor deposition or ion beam sputtering. While the thickness of protective layer 5 depends on various factors and is determined within a wide range, it should preferably be 2 to 10 nm.

Incidentally, a lubricating layer 7 may be formed on the protective layer 5. The lubricating layer is normally made of a fluorocarbon resin and has a thickness of about 1 to 2 nm.

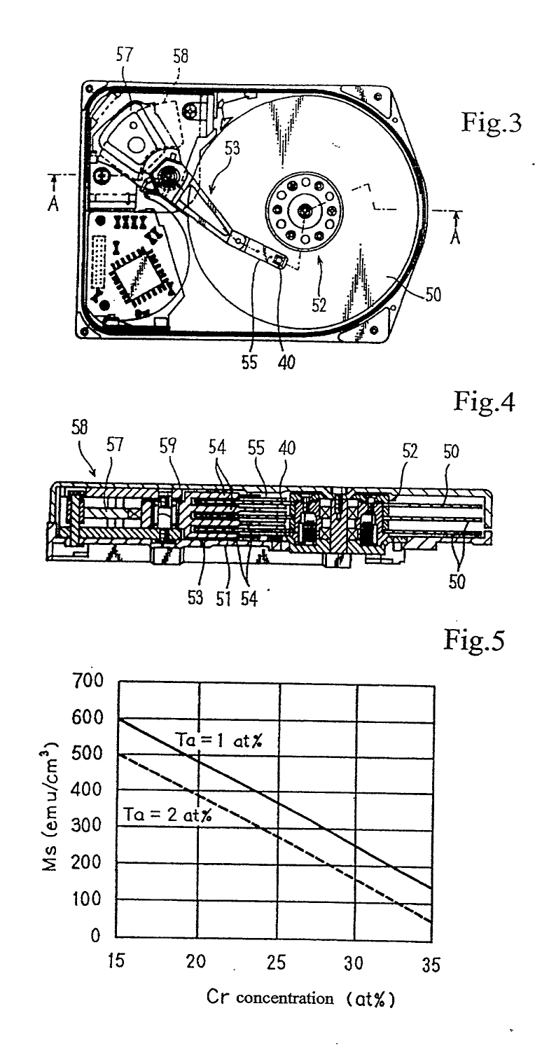

The present invention can be used in a magnetic disk device having the magnetic recording medium described above. An example of this is shown in FIGS. 3 and 4. FIG. 3 is a top view of the magnetic disk device of this invention with the cover removed. FIG. 4 is a cross sectional view of the portion shown by line A-A of FIG. 3.

A magnetic disk 50 is driven by spindle motor 52 provided on a base plate 51. In this embodiment there are three magnetic disks.

An actuator 53 is supported so that it may rotate on the base plate 51. On one end of the actuator 53 numerous head arms 54 extend in a direction parallel to the recording surface of the magnetic disk 50. Spring arms 55 are mounted on one end of head arms 54. Slider 40 is mounted to the flexure portion of spring arm 55 by virtue of an insulation layer (not shown). Coil 57 is mounted to the other end of the actuator 53.

Magnetic circuit 58 configured with a permanent magnet and yoke is provided on baseplate 51 and the coil 57 is disposed in the magnetic gap of circuit 58. Then voice coil motor (VCM) is configured with magnetic circuit 58 and coil 57. The top of the base plate 51 is covered with a cover 59.

When the magnetic disk 50 is stopped, the slider 40 contacts the refuge (or parking) zone of the magnetic disk 50 and is stopped. Next, if the magnetic disk 50 is rotated by spindle motor 52, the slider 40 floats up from the disk surface with a small gap due to an air current generated in conjunction with the rotation of the disk 50. If a current is passed through the coil 57 when the slider 40 is floated up from the surface of the disk, a thrust is generated in the coil 57 and the actuator 53 rotates. The slider 40 moves to a designated track of magnetic disk 50 and reads and writes data.

A CrMo₁₀ at %, a CoCrPtTa magnetic layer and a protective layer are formed successively with a DC magnetron sputtering device on an Al substrate that has been washed thoroughly, and are coated with NiP which is then surface processed. Prior to formation of the underlayer, the sputtering chamber has been evacuated of 3×10−10 Torr and less and the substrate heated to 220 C. When each layer is formed, Ar gas is introduced into the sputtering chamber so that a vacuum of 5 m Torr is maintained and a bias voltage of −110 is applied. The underlayer and magnetic layer formation are 25 nm and 20 nm, respectively.

While the test results shown below concern an instance in which an NiP coated Al substrate was used for a non-magnetic substrate, the same results were obtained when a glass substrate was used. In particular, when a glass substrate which had a layer formed with NiP sputtering was used, test results on a par with those obtained with an Al substrate coated with NiP were obtained.

FIG. 5 shows the Cr concentration dependence of saturation magnetization (Ms) of a CoCrPtTa medium in which Pt concentration is fixed and Ta concentration is fixed at 1 at % or 2 at %.

By using MR heads and GMR heads, readout sensitivity has been improved significantly over inductive heads. The criterion for reading magnetic information with MR heads and GMR heads is that the saturation magnetization of a magnetic recording medium preferably be 200 emu/cm³ or greater. As FIG. 5 shows, saturation magnetization decreases with the increase in Cr concentration in media having CoCrPtTa in magnetic layers. Unless Cr concentration is decreased to the extent that Ta additive concentration is high, a uniform saturation magnetization cannot be obtained. Given the test results shown in FIG. 5, it is necessary to maintain Cr concentration at about 32 at % or less in order to maintain saturation magnetization at 200 emu/cm³ or greater when the Ta concentration is 1 at %, and it is necessary to maintain Cr concentration at about 28 at % or less when Ta concentration is 2 at %. It may be assumed that 200 emu/cm³ cannot be obtained even when Ta is 0 at % unless Cr concentration is 35 at % or less. Thus, Cr concentration should preferably be 35 at % or less.

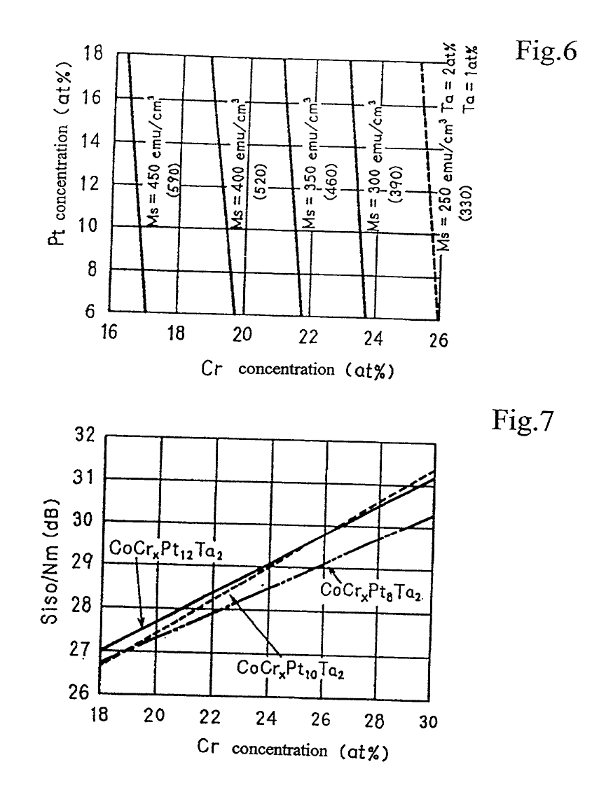

Saturation magnetization is comparatively insensitive to Pt concentration in magnetic recording media having CoCrPtTa in their magnetic layers, and the dependence on Cr and Ta concentration is great. As FIG. 6 shows, if Cr and Pt concentrations are uniform, there is approximately a 100 emu/cm³ difference in saturation magnetization with just a 1 at % variation of Ta concentration. Also, if Pt and Ta concentrations are uniform, with a 10 at % variation of Cr concentration, saturation magnetization will vary 20 emu/cm³. However, if Cr and Ta concentrations are uniform, variation of saturation magnetization will be insensitive to variation of Pt.

FIG. 7 shows the Cr concentration dependence characteristics of the solitary wave signal to noise ratio of a magnetic recording medium with a CoCrPtTa medium which has its Pt and Ta concentration fixed.

If Cr is added to Co, it is known that Cr is deposited on the particle boundary of magnetic particles and an area of high Cr concentration is formed. This area of non-magnetic high Cr concentration which exists between these Co magnetic particles functions to reduce the mutual magnetic action between magnetic particles, and enhances or improves the recording readout characteristics of a magnetic recording medium. As FIG. 7 shows, if Ta and Pt concentrations are the same in a CoCrPtTa medium, the solitary wave signal to noise ratio increases along with increases in Cr concentration. Given the need to ensure a solitary wave signal to noise ratio of 30 dB or greater due to demands for lesser amounts of noise for media in recent years, a Cr concentration of 26 at % or greater is preferred. In addition, solitary wave signal to noise ratio is somewhat dependent on Pt and as FIG. 7 shows, there is a tendency for Pt concentrations to be larger. Thus, without relying on Pt concentration, it is preferable that Cr concentration be even higher at 30 at % to ensure a signal to noise ratio of 30 dB or greater.

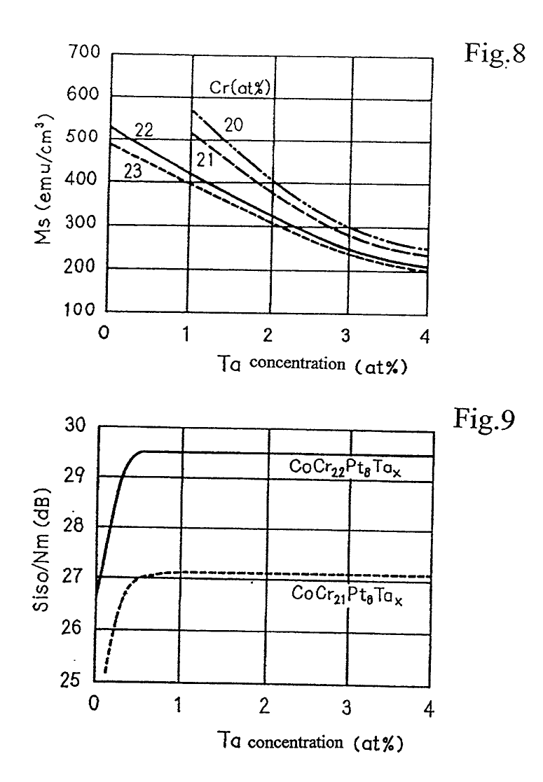

FIG. 8 shows the Ta concentration dependence characteristics of saturation magnetization (Ms) of a CoCrPtTa medium in which the Cr concentration is fixed.

As FIG. 8 shows, saturation magnetization decreases along with increases in Ta concentration in a CoCrPtTa medium with a uniform Cr concentration. Ta concentration must be reduced to the extent that Cr concentration is high in order to obtain a uniform saturation magnetization. For example, if Cr concentration is 23 at %, and Ta concentration is 0 at %, saturation magnetization will indicate about 500 emu/cm³ and if Ta concentration is increased to 4 at %, saturation magnetization will decrease to about 200 emu/cm³. Thus, as described above, given that Cr concentration needs to be 26 at % or greater in order to increase solitary wave signal to noise ratio, and that a saturation magnetization of 200 emu/cm³ is necessary in reading magnetic information with MR heads and GMR heads, Ta concentration should preferably be 4 at % or greater.

FIG. 9 shows the Ta concentration dependence characteristics of solitary wave signal to noise ratio in a magnetic recording medium which used Co₇₀₋ₓCr₂₂Pt₈Taₓ in the magnetic layer, and CrMo₁₀ in the underlayer, in a magnetic recording medium which used Co₇₁₋ₓCr₂₁Pt₈Taₓ and CrMo₁₀ in the underlayer.

As seen in FIG. 9, with either medium, solitary wave signal to noise ratio shows a uniform value and does not depend on the Ta concentration if the Ta additive concentration is 0.5 at % or greater, but in the range below about 0.5 at %, solitary wave signal to noise ratio is significantly degraded. Thus, considered together with the saturation magnetization Ta concentration dependence characteristics indicated earlier in FIG. 8, it is preferable to select from a composition range of 0.5 at % to 4 at % for Ta concentration, in order to ensure a large saturation magnetization and solitary wave signal to noise ratio.

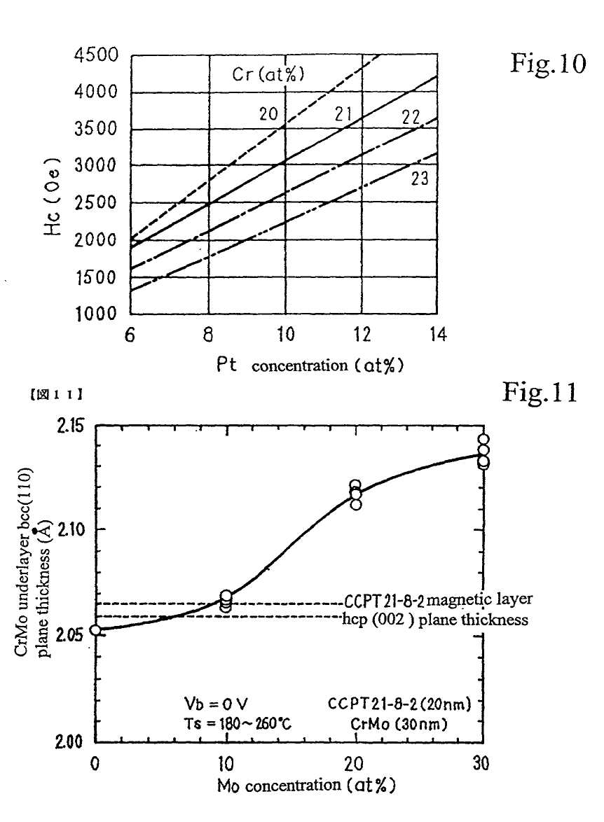

FIG. 10 is shows the coercive force Hc vs. Pt concentration dependence characteristics in a magnetic recording medium having a magnetic layer consisting of CoCrPtTa.

Adding Pt has the effect of increasing the coercive force (Hc) of a CoCrPtTa medium. It is thought that 2500 Oe or greater coercive force (Hc) is necessary in a magnetic recording medium which exceeds 3 Gbit/in². As FIG. 10 shows, coercive force (Hc) increases along with increases in the additive concentration of Pt. Also, Pt concentration must be raised to the extent that Cr concentration is high in order to obtain a uniform coercive force (Hc). Considering that the Cr concentration necessary to ensure acceptable solitary wave signal to noise ratio is 26 at % or greater as described earlier, a Pt concentration of 15 at % or greater is preferable in order to maintain coercive force (Hc) at or above 2500 Oe.

Meanwhile, factors for a magnetic layer having a high hexagonal close-packed structure in a CoCrPtTa medium are that the magnetic particles have an hop structure, that it have a strong single anisotropic nature, and that its axis of magnetization be disposed in the plane of the medium. Because there is an upper limit of Pt concentration when forming a magnetic layer of CoCrPtTa by sputtering, it is preferable that the range that can stably make an hop structure be 30 at % or less. Thus, the Pt concentration of a CoCrPtTa medium for ensuring a high coercive force (Hc) and stable hop structure should preferably be chosen in the composition range of 15 at % to 30 at %.

If Nb is further added to a CoCrPtTa medium, the size of magnetic particles as well as the size distribution of them can be controlled. More specifically, the average particle size of magnetic particles of a medium to which Nb has not been added is 15 nm, and the particle size range (standard deviation) is 4.2 nm, whereas, the average particle size decreases to 12.7 and the particle size range decreases to 3.6 in a medium to which 2 at % Nb has been added. Along with this the signal to noise ratio improves 0.6 dB.

The underlayer and the intermediate layer will now be explained.

FIG. 11 shows the Mo dependence characteristics of the bcc (110) plane interval of a CrMo underlayer. In the same drawing, the hop (002) plane interval of a CoCr₂₁Pt₈Ta₂ magnetic layer is also shown. Here, the magnetic layer and underlayer were formed by sputtering with a DC bias voltage of 0 V, and at various substrate temperatures from 180 C to 260 C. The thickness of the magnetic layer is 20 nm and the thickness of the underlayer is 30 nm.

The underlayer is provided to enhance the C axis in-plane orientation of the magnetic layer consisting of CoCrPtTa. As FIG. 11 shows, the bcc (110) plane interval of the underlayer is significantly dependent on Mo concentration, and to the extent that Mo concentration is high, the interval increases. Also, the hcp (002) plane interval of the CoCr₂₁Pt₈Ta₂ magnetic layer is somewhat dependent on the substrate temperature at the time the layer is formed, and a different value was obtained corresponding to substrate temperature.

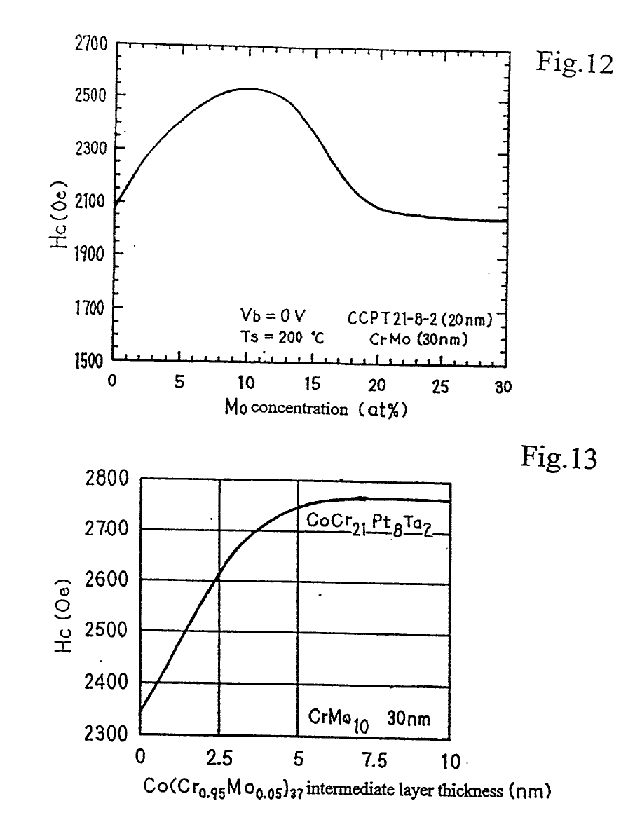

FIG. 12 shows the underlayer Mo concentration dependence characteristics of coercive force Hc of a CoCr₂₁Pt₈Ta₂ magnetic layer. Here, the underlayer and magnetic layer were formed by sputtering with a DC bias voltage Vb of 0 V and a substrate temperature Ts of 200 C. The thickness of the magnetic layer was 20 nm and the thickness of the underlayer was 30 nm.

As FIG. 12 shows, the coercive force (Hc) shows characteristics of dependence on Mo concentration of the underlayer and is greatest when the hcp (002) plane interval of a CoCr₂₁Pt₈Ta₂ magnetic layer and the bcc (110) plane interval of a CrMo underlayer are nearly equal (actually it is the greatest when the (002) plane interval of a CoCr₂₁Pt₈Ta₂ magnetic layer is several % smaller than the bcc (110) plane interval of a CrMo underlayer). In this example, CrMo is used for the underlayer though the same results can be obtained with an underlayer which has Cr as the main constituent to which W, Ti, Ir, Ru are added. Also, it is expected that the same results can be obtained with an underlayer which has Cr as the main constituent to which 2 or more of the following have been added: Mo, W, Ti, Ir, Ru and Re.

FIG. 13 shows the intermediate layer thickness dependence characteristics of coercive force (Hc) of a magnetic recording medium which has CrMo₁₀ for an underlayer, CoCr₂₁Pt₈Ta₂ as a magnetic layer and further has a Co(Cr_{0.95}Mo_{0.05})₃₇ intermediate layer provided between the underlayer and the magnetic layer. Here the thickness of the underlayer is 30 nm.

As FIG. 13 shows, coercive force (He) shows a tendency to rise until the thickness of the intermediate layer is 8 nm. At the point that it exceeds 8 nm, coercive force (Hc) shows a uniform value and coercive force (Hc) improves over a medium which does not have an intermediate layer (intermediate layer thickness 0 nm).

FIG. 13 shows the intermediate layer thickness dependence characteristics of signal to noise ratio of a magnetic recording medium which has CrMo₁₀ for an underlayer, CoCr₂₁Pt₈Ta₂ as a magnetic layer and further has a Co (Cr_{0.95}Mo_{0.05}) intermediate layer provided between the underlayer and the magnetic layer. Here the thickness of the underlayer is 30 nm.

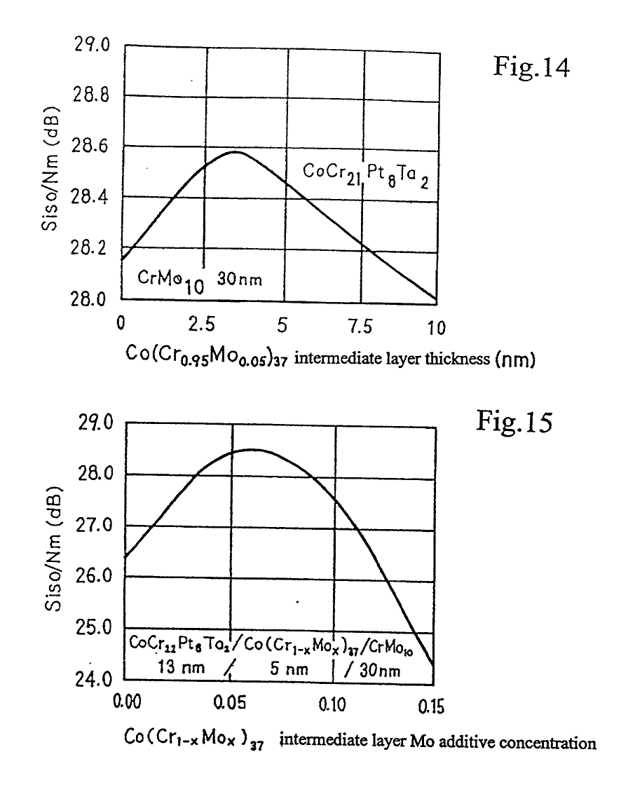

As FIG. 14 shows, signal to noise ratio shows a tendency to rise until the thickness of the intermediate layer is about 3 nm. At the point that it exceeds 3 nm, signal to noise ratio tends to decrease. Moreover, when the intermediate layer exceeds 8 nm, signal to noise ratio shows characteristics of degrading more than for a medium without an intermediate layer. From the characteristics shown in FIGS. 13 and 14, it appears preferable to select an intermediate layer within a range of thickness of 1 to 8 nm.

FIG. 15 shows the Mo additive concentration dependence characteristics of solitary wave signal to noise ratio in a magnetic recording medium provided with an underlayer of CrMo₁₀ which is 30 nm thick, a magnetic layer of CoCr₂₂Pt₈Ta₂ which is 13 nm thick and an intermediate layer of Co (Cr₁₋ₓMoₓ)₃₇ which is 5 nm thick.

As FIG. 15 shows, combining the previously described underlayer and intermediate layer Co (Cr_{0.95}Mo_{0.05})₃₇ obtained the best characteristics. This is because when Co (Cr_{0.95}Mo_{0.05})₃₇ is used as an intermediate layer, there is the least lattice mismatch of the underlayer and magnetic layer.

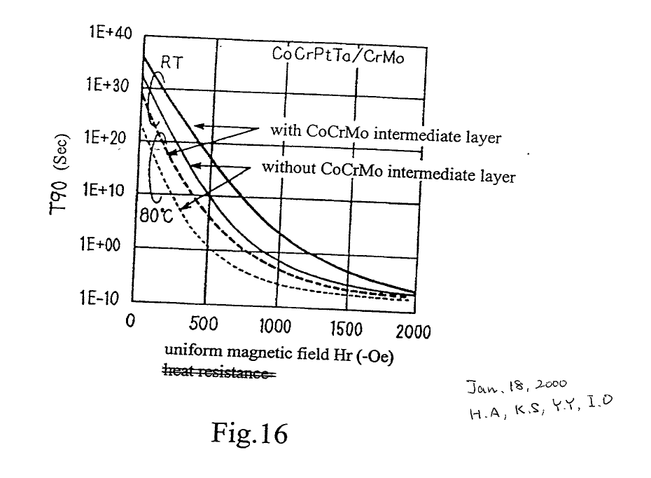

FIG. 16 shows the stability of the magnetization of a medium without an intermediate layer (intermediate layer thickness 0 nm) and a medium with an intermediate layer (intermediate layer thickness 3 nm). Here, a 15 Oe magnetic field was added in a uniform direction with a SQUID and then later the time change of residual magnetization was measured in a state when a uniform magnetic field was applied in the opposite direction (Hr). The vertical axis represents the time necessary (T90) for residual magnetization to decrease 10% (to 90%) with the reference point being the residual magnetization after 1 second. The measurement was carried out under conditions of room temperature (RT=27 C) and 80 C.

It is seen in FIG. 16 that thermal resistance improves by providing a CoCrMo intermediate layer. While the results shown in FIG. 16 are for a CoCrMo intermediate layer, the same results can be obtained with an alloy containing W, Ti, Ir, Ru, and Re besides Mo.

High signal to noise ratio and large saturation magnetization can be obtained with this invention by providing a magnetic layer whose main constituent is Co and whose Cr concentration is 26 to 35 at % and Ta concentration is 0.5 to 4 at % as the recording layer of a magnetic recording medium. As a result, low noise and improvement of readout characteristics of a magnetic recording medium can be obtained and high recording density of magnetic recording media can be achieved.

Also, by disposing a non-magnetic intermediate layer with an hcp structure between a magnetic layer and a non-magnetic underlayer, magnetic information is stabilized for a long time and the reliability of magnetic recording media is improved.

While the principles of the invention have been described above in connection with specific apparatus and applications, it is to be understood that this description is made only by way of example and not as a limitation on the scope of the invention.

What is claimed is:

1. A magnetic recording medium on a non-magnetic substrate comprising a magnetic layer containing Co, with about 26 to 35 at % Cr and about 0.5 to 4 at % Ta added.

2. The magnetic recording medium of claim 1 wherein said magnetic layer also has 15 to 30 at % Pt.

3. The magnetic recording medium of claim 2 wherein said magnetic layer also has Nb.

4. The magnetic recording medium of claim 2 comprising an underlayer between said substrate and said magnetic layer, said underlayer containing Cr as its main constituent and containing one or more of Mo, W, Ti, Ir, Ru and Re.

5. The magnetic recording medium of claim 1 comprising a non-magnetic intermediate layer between said underlayer and said magnetic layer, said non-magnetic layer having a hexagonal close-packed structure.

6. A magnetic disk device comprising:
at least one magnetic recording medium driven by a spindle motor,
at least one head configured to float adjacent to the medium, said head being capable of writing data on the medium, and reading data from the medium,
wherein said magnetic recording medium is on a nonmagnetic substrate and includes a magnetic layer containing Co with about 26 to 35 at % Cr and about 0.5 to 4 at % Ta added.

7. A magnetic disk device according to claim 6 wherein said magnetic layer also has 15 to 30 at % Pt.

8. A magnetic disk device according to claim 7 wherein said magnetic layer also has Nb.

9. A magnetic disk device according to claim 7 comprising an underlayer between said substrate and said magnetic layer, said underlayer containing Cr as its main constituent and containing one or more of Mo, W, Ti, Ir, Ru and Re.

10. A magnetic disk device according to claim 6 comprising a nonmagnetic intermediate layer between said underlayer and said magnetic layer, said nonmagnetic layer having a hexagonal close-packed structure.
